(19) United States
(12) Patent Application Publication
(10) Pub. No.: US 2009/0167760 A1
(43) Pub. Date: Jul. 2, 2009

(54) Triangle Mesh Based Image Descriptor

(75) Inventors: Kongqiao Wang, Beijing (CN); Xiujuan Chai, Beijing (CN)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/965,355

(22) Filed: Dec. 27, 2007

(51) Int. Cl. G06T 15/30

(52) U.S. Cl. 345/423

(57) ABSTRACT

Embodiments are directed to creating a triangle mesh by using a distance-minimum criterion on a plurality of feature points detected from an image, computing, based on the triangle mesh, global features that describe a global representation of content of the image, and computing, based on the triangle mesh, local features that describe a local representation of content of the image. The global features may include a triangle distribution scatter of mesh that shows a texture density of the content of the image and a color histogram of mesh region that represents image color information corresponding to a mesh region of interest. The local features may include a definition of each mesh triangle shape via its three angles and a color histogram of each mesh triangle to represent image color information corresponding to each triangle region.

### FIELD

Embodiments relate generally to digital image processing. More specifically, embodiments relate to a triangle mesh based image descriptor.

### BACKGROUND

With the increasing popularity of mobile camera devices and high-speed mobile Internet, the ability to search an image database for images that match a query image captured by a mobile camera device is desirable. The query image may be sent, e.g., via a mobile Internet connection, to an image search system so that similar images may be searched from a remote image database. Further, mobile device users would typically like to find context (i.e., semantic) information related to visual objects in the physical world by taking a picture of the objects. As such, a service that would allow mobile device users to take pictures of objects and receive information about the objects from a database containing semantic context information about images would be regarded as a value-added service. For example, by taking a picture of a movie advertisement that includes a picture, the context information about the movie, such as, who the main actors and actresses are, what the movie is about, and the like, may be displayed for review by the user on the display screen of mobile terminal. FIG. 1 is a schematic diagram of an example of such an image matching system in accordance with the prior art.

A visual interaction based service of the type mentioned above depends heavily upon being able to effectively and efficiently perform image matching, which, in turn, depends upon having a robust descriptor of image content. It is typically quite challenging to define an image descriptor that is insensitive to image noise, geometric distortion, spatial translation variation, rotation variation, scale variation, and the like, and that still optimizes both local and global image content representations. Conventional image descriptors typically can be classified into two categories: global image descriptors and local image descriptors. Global image descriptors focus on the description of the whole image vector, such as global histogram, image gradient, and so on. While local image descriptors are the image local features extracted around previously detected interest points, and the image is represented by all or some of these local features. Although local descriptors have strong representative ability, they typically fail to utilize global information of the image, thereby limiting their effectiveness in representing image content. As such, an improved image descriptor would advance the art.

### BRIEF SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Embodiments are directed to creating a triangle mesh by using a distance-minimum criterion on a plurality of feature points detected from an image, computing, based on the triangle mesh, global features that describe a global representation of content of the image, and computing, based on the triangle mesh, local features that describe a local representation of content of the image. The global features may include a triangle distribution scatter of mesh that shows a texture density of the content of the image and a color histogram of mesh region that represents image color information corresponding to a mesh region of interest. The local features may include a definition of each mesh triangle shape via its three angles and a color histogram of each mesh triangle to represent image color information corresponding to each triangle region.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a schematic diagram of an example of an image matching system in accordance with the prior art.

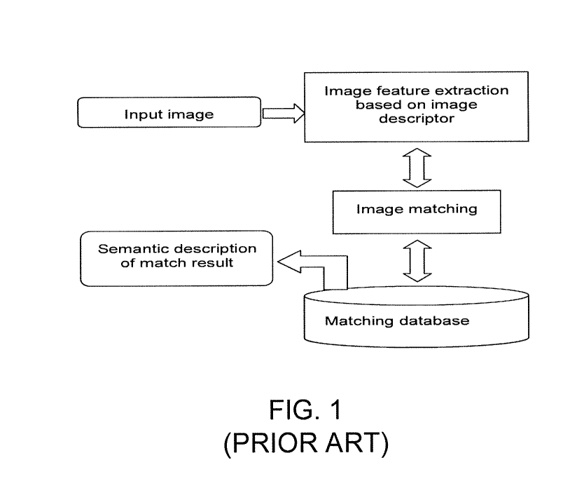

FIG. 2 is a schematic block diagram of a mobile terminal according to an exemplary embodiment of the present invention.

FIG. 3 is a schematic block diagram of a wireless communications system according to an exemplary embodiment of the present invention.

FIG. 4 shows a system for generating a triangle mesh based image descriptor in accordance with certain embodiments.

FIG. 5 shows steps of a method for generating a triangle mesh based image descriptor in accordance with certain embodiments.

FIG. 6 depicts an example of a triangle mesh constructed in accordance with certain embodiments.

FIG. 7 depicts a mesh construction for an example image in accordance with certain embodiments.

FIG. 8 illustrates a color histogram in accordance with certain embodiments.

FIG. 9 illustrates the formation of the color histogram of triangle mesh region from the color histograms of triangles in accordance with certain embodiments.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

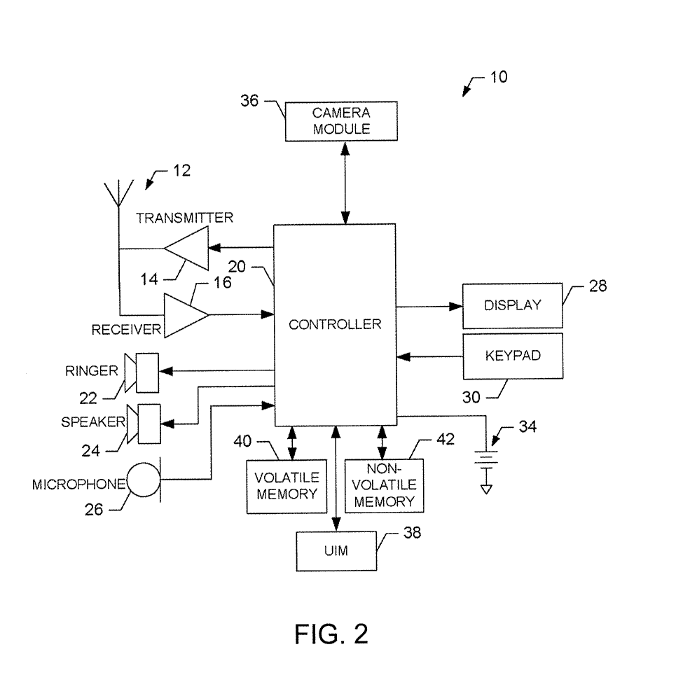

FIG. 2 illustrates a block diagram of a mobile terminal 10 in which certain embodiments may be implemented. It should be understood, however, that a mobile telephone as illustrated and hereinafter described is merely illustrative of one type of mobile terminal in which embodiments may be implemented and, therefore, should not be taken to limit the scope of the present invention. Embodiments may be implemented in other types of mobile terminals, such as portable digital assistants (PDAs), pagers, mobile televisions, laptop computers and other types of voice and text communications systems. Furthermore, embodiments may be implemented in devices that are not mobile.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In certain embodiments, the mobile terminal 10 includes a camera module 36 in communication with the controller 20. The camera module 36 may be any means for capturing an image for storage, display or transmission. For example, the camera module 36 may include a digital camera capable of forming a digital image file from a captured image. As such, the camera module 36 includes all hardware, such as a lens or other optical device, and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In certain embodiments, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

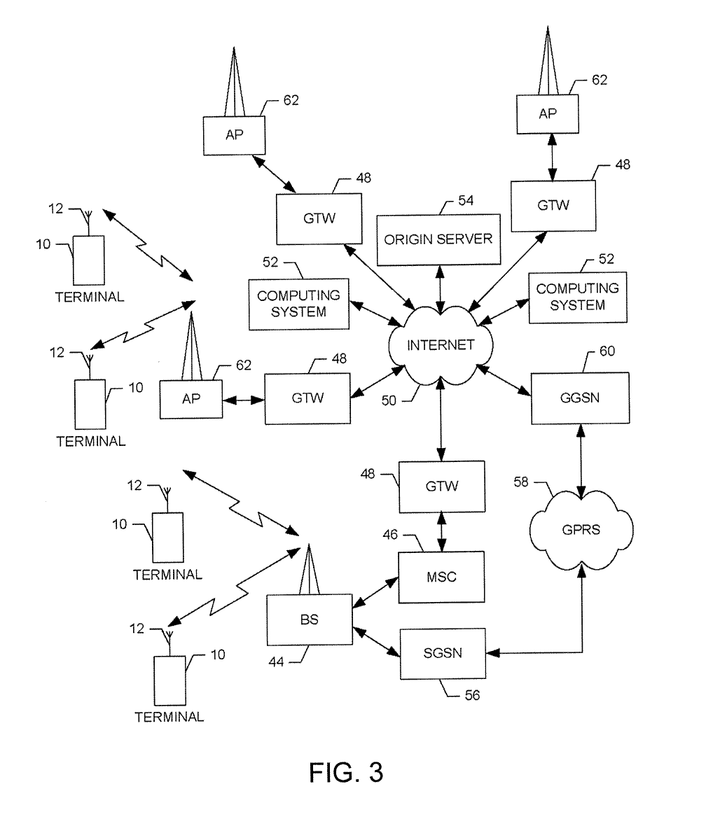

FIG. 3 is an illustration of one type of system in which various embodiments may be implemented. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 3, the MSC 46 is merely an exemplary network device and embodiments are not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In certain embodiments, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements may include one or more processing elements associated with a computing system 52 (two shown in FIG. 3), origin server 54 (one shown in FIG. 3) or the like, as described below.

The BS 44 may also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, may be coupled to a data network, such as the Internet 50. The SGSN 56 may be directly coupled to the data network. In certain embodiments, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 may be further coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 may be directly coupled to the Internet 50. In certain embodiments, however, the APs 62 are indirectly coupled to the Internet 50 via a GTW 48. Furthermore, in certain embodiments, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments.

Although not shown in FIG. 3, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 may additionally, or alternatively, include a removable memory capable of storing content, which may thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

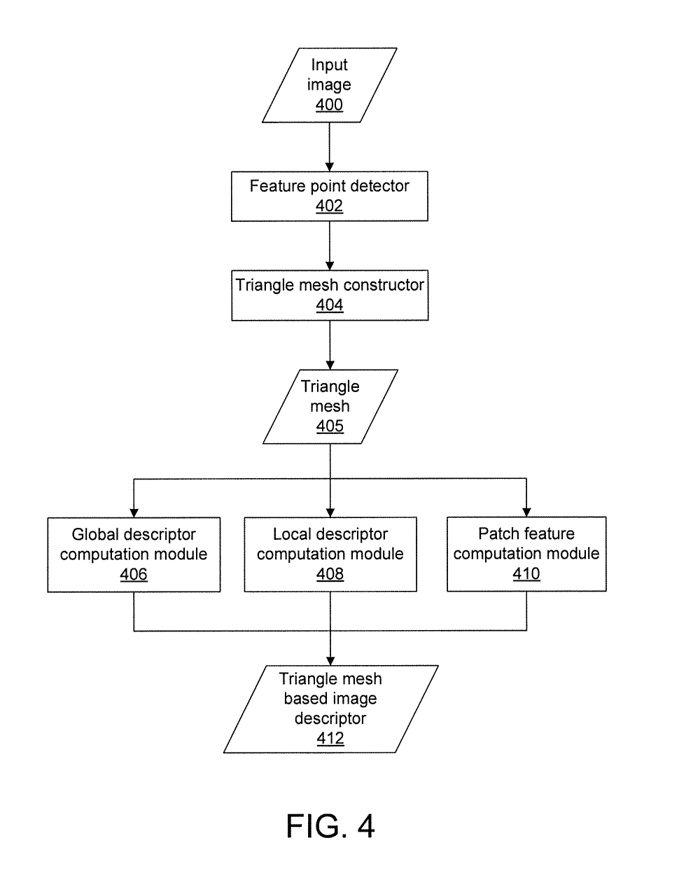

Certain embodiment will now be discussed with reference to FIG. 4, in which certain elements of a system for computing a triangle mesh based image descriptor are displayed. The system of FIG. 4 may be employed, for example, on the mobile terminal 10 of FIG. 2. However, it should be noted that the system of FIG. 4 may also be employed on a variety of other devices, both mobile and fixed, and therefore, embodiments should not be limited to application on devices such as the mobile terminal 10 of FIG. 2. The following description of various embodiments is given by way of example and not of limitation. While FIG. 4 illustrates one example of a configuration of the system, numerous other configurations may also be used to implement various embodiments.

The system of FIG. 4 includes a feature point detector 402 configured to detect feature points (e.g., corner points in an image) from an input image 400. The feature point detector may be implemented in accordance with the discussion of feature point detection in U.S. patent application Ser. No. 11/428,903, filed Jul. 6, 2006, by Kongqiao Wang et al., which is discussed in more detail below. Alternatively, the feature point detector may be implemented in accordance with the discussion of feature point detection in D. Lowe, Distinctive Image Features from Scale-Invariant Keypoints, Cascade Filtering Approach. IJCV, 60: 91-110, 2004 or the discussion of feature point detection in H. Bay, et al., SURF: Speeded Up Robust Features. ECCV, I:404-417, 2006. Certain embodiments may accept feature points detected by a separate component and, therefore, do not include a feature point detector.

A triangle mesh constructor 404 is configured to create a triangle mesh 405 with feature points as mesh nodes based on distance-minimum criterion, as is discussed in more detail below. The resulting triangle mesh is affine-invariant in accordance with certain embodiments.

A global descriptor computation module 406 is configured to compute global features that describe a global representation of image content. The global descriptor computation module computes a triangle distribution scatter of mesh based on the constructed triangle mesh. The triangle distribution scatter of mesh is computed to show the texture density of the image content, and a color histogram of mesh region is computed to represent image color information corresponding to a mesh region of interest. These global features, namely, the triangle distribution scatter of mesh and the color histogram of mesh region, describe a global representation of image content.

A local descriptor computation module 408 is configured to compute local features that describe a local representation of image content. The local descriptor computation module defines each mesh triangle shape with its three angles, and computes a color histogram of each mesh triangle to represent image color information corresponding to the triangle region. These local features, namely, triangle mesh shape and mesh triangle color histogram, describe a local representation of image content. The shape of a triangle may be represented by its three angles. If the three angles are the same for two triangles, then the two triangles are similar and have a scale variation, i.e. they have the same shapes (although not necessarily the same size). So the similarity of the shapes of two triangles may be evaluated by the similarity of the corresponding angles.

A patch feature computation module 410 is configured to compute a patch feature around each feature point region based on the detected feature points in an image. The patch feature computation module may be configured to compute patch features in accordance with various techniques, several of which are known in the art, including, but not limited to, the discussion of computation of patch features in D. Lowe, Distinctive Image Features from Scale-Invariant Keypoints, Cascade Filtering Approach. IJCV, 60: 91-110, 2004, and the discussion of computation of patch features in H. Bay, et al., SURF: Speeded Up Robust Features. ECCV, I:404-417, 2006.

A triangle mesh based image descriptor 412 comprises the global features, the local features, and the patch feature discussed above.

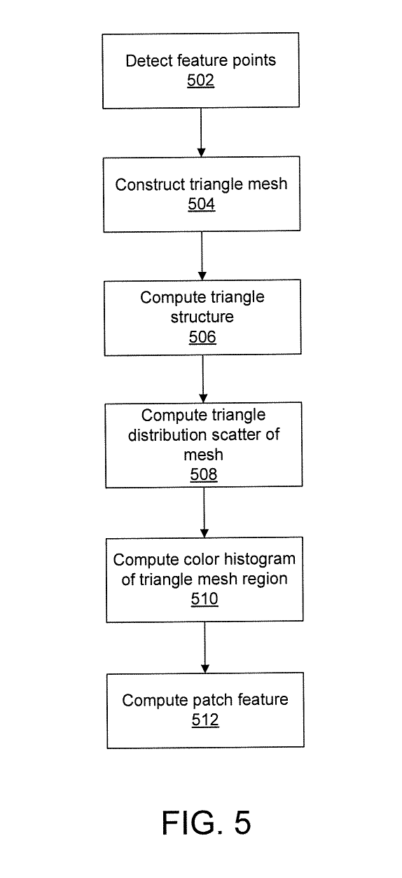

FIG. 5 shows steps of a method for generating a triangle mesh based image descriptor in accordance with certain embodiments.

Feature points are detected from an input image, as shown at 502. Feature point detection from an image may be performed by various methods, which are known in the art, as is discussed in A. Alexandrov. Corner Detection Overview and Comparison. Computer Vision “http://www.cisnav.com/alex/cs558/CornerDet.pdf”, 2002. The robust feature point detection method disclosed in U.S. patent application Ser. No. 11/428,903, filed Jul. 6, 2006, by Kongqiao Wang et al., may also be used. To summarize this feature point detection method, assume a potential corner block that has eight neighboring blocks surrounding the potential corner block of a particular image frame. Each of the blocks may represent a pixel. As such, each of the blocks may include a greyscale value descriptive of information associated with the pixel. Alternatively, each of the blocks may represent a group of pixels. In any case, if the potential corner block is a pixel or pixel group representing a corner of an object in a particular image, then there should be a relatively large greyscale or color difference between the corner block and the eight neighboring blocks in at least two directions. Meanwhile, if the potential corner block instead represents, for example, a portion of a side edge of an object, then only blocks along the edge (i.e., blocks in one direction) may have substantially different greyscale values than that of the potential corner block, while all remaining blocks may have substantially similar greyscale values to that of the potential corner block. Furthermore, if the potential corner block is disposed at an interior portion of an object, the potential corner block may have a substantially similar greyscale value to that of each of the eight neighboring blocks.

The difference in energy amount E between a given image block and eight neighboring blocks of the given image block is written as shown in Equation (1) below.

$$E ( x , y ) = {\sum }_{u , v} {W}_{u , v} {\vert {I}_{x + u , y + v} - {I}_{x , y} \vert}^{2} \qquad ( 1 )$$

In Equation (1), I_{x,y} represents the given image block, I_{x+u, y+v} represents the eight neighboring blocks, and W_{u,v} represents the weighted values for each of the eight neighboring blocks. The above formula is decomposed in Taylor criteria at (x, y) as shown below in Equation (2).

$$E ( x , y ) = {\sum }_{u , v} {W}_{u , v} {\vert xX + yY + O ( {x}^{2} , {y}^{2} ) \vert}^{2} \qquad ( 2 )$$

In Equation (2), X=I [symbol] (−1,0,1)=∂I/∂x, and Y=I [symbol] (−1,0,1)^{T}=∂I/∂y. Further, Equation (2) can be described as shown below in Equation (3).

E(x,y)=Ax²+2Cxy+By² (3)

In Equation (3), A=X² [symbol] w, B=Y² [symbol] w, and C=(XY) [symbol] w. Variable w represents a window region including the potential corner block and the eight neighboring blocks with a center at point (x,y). Finally, E(x,y) can be written in matrix form as shown in Equation (4) below.

$$E ( x , y ) = ( x , y ) {M ( x , y )}^{T} , where M = [ \begin{matrix}A & C \\ C & B\end{matrix} ] \qquad ( 4 )$$

In Equation (4), M describes a shape of E(x, y), if both eigenvalues of M are relatively small, then the given block is likely part of a smooth region. If both eigenvalues of M are relatively large, and E(x, y) shows a deep vale, then the given block likely includes a corner. If one eigenvalue is relatively large, while the other eigenvalue is relatively small, then the given block likely includes an edge.

Throughout an image frame, the two M eigenvalues of each pixel point are calculated by a feature extractor, and those points for which both M eigenvalues are relatively large may be considered to be potential corners or feature points. For each potential corner in a same frame, a smaller M eigenvalue of the two relatively large M eigenvalues is sorted, and then a predetermined number of feature points are selected from among the potential corners which have the largest smaller M eigenvalues.

A triangle mesh is constructed as shown at 504. Based on the detected feature points, P={P₁, P₂, . . . , P_{M}}, a triangle mesh T={T₁, T₂, . . . , T_{N}}, which is invariable for the scale, rotation, and translation variations may be erected as follows: (1) compute lines composed by the points in P, and get a line list according to the ascending order of the length: L={L₁, L₂, . . . , Lₖ}, where Lᵢ≦Lⱼ,if(i≦j) and K=M(M−1)/2. A blank line set L_{B}=Φ may be set up and, in the initialization, T=Φ; the following iterative construction procedure is then performed based on distance-minimum criterion: (2) Select a line from L with a smallest length, that is Lᵢ, that also satisfies the condition that Lᵢ∉L_{B} (in the first iteration, i=1); (3) taking Lᵢ to be a fixed line, construct a triangle Tⱼ with a smallest perimeter based on the lines in L; (4) if Lᵢ=Lᵢ₊₁, compare the perimeter of triangles Tⱼ and Tⱼ₊₁, the line corresponding to a smaller perimeter is recorded as Lᵢ, and the corresponding triangle is recorded as Tⱼ, then the other line is recorded as Lᵢ₊₁. If the two perimeters for Tⱼ and Tⱼ₊₁, are equal, the secondary smaller perimeter based on Lᵢ and Lᵢ₊₁ is considered to choose Lᵢ from lines with the same length; (5) add the constructed triangle Tⱼ into T, i.e. T=T∪{Tⱼ}; (6) add the three lines of the constructed triangle Tⱼ into L_{B}, i.e., L_{B}=L_{B}∪{Lₖ|Lₖ is the line of Tⱼ}; (7) if one line of the added triangle Tⱼ can construct triangle Tₘ with the lines in L_{B} and Tₘ∉T, then set Tⱼ₊₁=Tₘ and add Tⱼ₊₁ into T, T=T∪{Tⱼ₊₁}; (8) delete the element in L for the line intersected with the triangle Tⱼ, i.e., L=L−{Lₖ|Lₖ is line intersecting with Tⱼ}; Repeat step (2) to (8), until L=L_{B}. Then, T={T₁, T₂, . . . , T_{N}} is a triangle mesh constructed for the description of the input image.

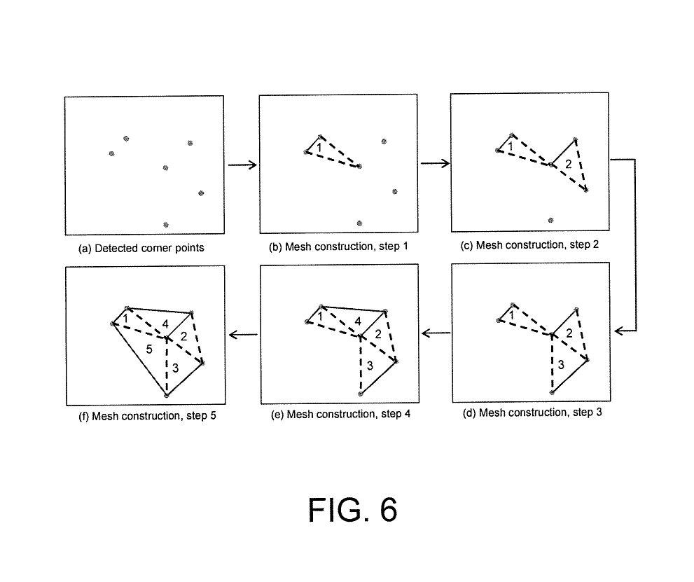

FIG. 6 depicts an example of a triangle mesh constructed in accordance with certain embodiments. It can be seen that, the construction criterion will produce substantially the same results for different affine transformations. Construction of a triangle mesh in accordance with certain embodiments is based on a distance-minimum criterion. For each line in the line list, affine transformation may make each line length changed (e.g. scale or rotation transformation). However, the length order of the lines in the list is unchangeable. That is to say, the lines with the minimum length under any affine transformation are always the same one. Therefore, based on the distance-minimum criterion, the constructed triangle meshes will be substantially the same for different affine transformations.

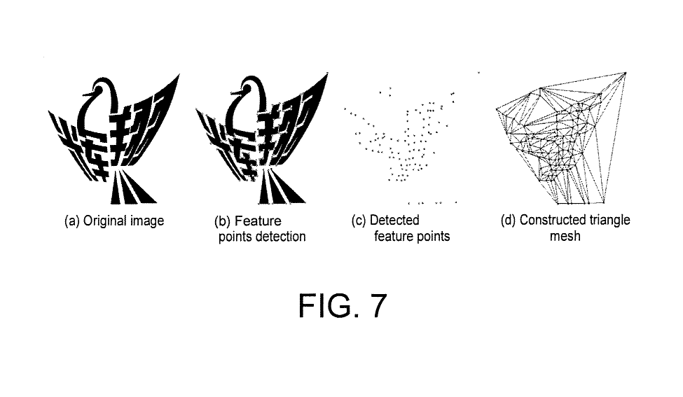

FIG. 7 depicts a mesh construction for an example image in accordance with certain embodiments.

Extraction of a triangle mesh based descriptor may be performed on the constructed triangle mesh and corresponding image content. Four components, namely, a triangle structure, a triangle distribution scatter of mesh, a color histogram of triangle mesh region, and a patch feature, may be generated as follows.

To generate a triangle structure in accordance with certain embodiments, as shown at 506, assume that the three angles of a mesh triangle Tⱼ are αⱼ,βⱼ,γⱼ and that the three angles are arranged counterclockwise such that αⱼ≦βⱼ,αⱼ≦γⱼ(γⱼ=π−αⱼ−βⱼ). Based on the geometric structure feature of the triangle, we further define a measurement to evaluate a degree of similarity of two triangles Tᵢ and Tⱼ:

$$D = 1 - \frac{1}{π} ( ‖ {α}_{i} - {α}_{j} ‖ + ‖ {β}_{i} - {β}_{j} ‖ ) . \qquad ( 5 )$$

A triangle distribution scatter may be defined for each mesh, as shown at 508, to evaluate a global texture density of an image. First, compute the centroid cⱼ(xⱼ,yⱼ) of each triangle Tⱼ. Then, compute the center point of the centroids for the triangles in the mesh:

$${c}_{0} ( {x}_{0} , {y}_{0} ) = \frac{1}{N} {\sum }_{j = 1}^{N} {c}_{j} ( {x}_{j} , {y}_{j} ) . \qquad ( 6 )$$

Here, N is the triangle number of a mesh.

Finally, the scatter R for triangle distribution of this mesh may be calculated according to Eq. (7):

$$R = \frac{1}{N \cdot Max ( W , H )} {\sum }_{j = 1}^{N} {d}_{j} , \qquad ( 7 )$$

Where, dⱼ=∥cⱼ(xⱼ,yⱼ),c₀(x₀,y₀)∥. W and H are the corresponding width and height of the image, respectively.

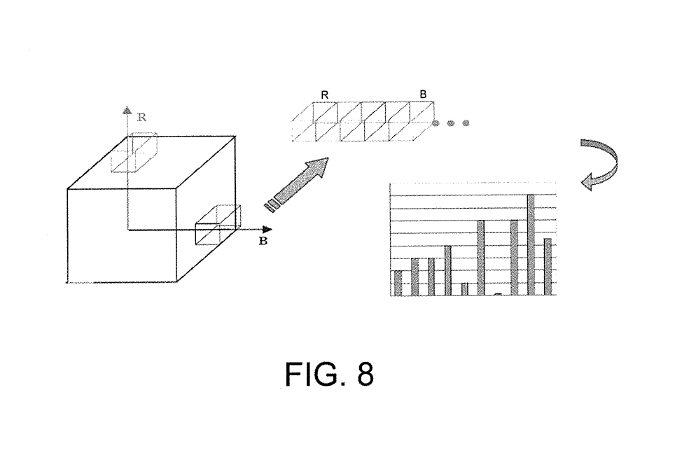

To compute a color histogram, as shown at 510, first, we classify the R, G, B (red, green, blue) color space into several relatively small spaces, and then count the number of pixels in each relatively small color space. FIG. 8 illustrates a color histogram in accordance with certain embodiments.

Formally, for each triangle Tⱼ, its color histogram H is computed according to Eq. (8):

$${H}_{i} = {\sum }_{( x , y )} C \{ f ( x , y ) = i \} / n , ( i = 0 , 1 , … , K ) , \qquad ( 8 )$$

### Where

$$\begin{matrix}f ( x , y ) = ( {I}^{R} ( x \cdot y ) / bin ) * bin * bin + \\ ( {I}^{G} ( x \cdot y ) / bin ) * bin + {I}^{B} ( x \cdot y ) / bin , \\ K = {max}_{( x , y )} ( f ( x , y ) ) ,\end{matrix}$$

bin is the category number classified for each color level, n is the total number of the pixels in the triangle Tⱼ, and C is a counting function, which is defined as:

$$C \{ f \} = \{ \begin{matrix}1 , & f is true \\ 0 , & f is false .\end{matrix} \qquad ( 9 )$$

Having gotten the color histograms for triangles, by integrating them, the color histogram of the triangle mesh region H^{Mesh} may be formed according to Eq. (10):

$${H}_{i}^{Mesh} = {\sum }_{j = 1}^{N} {H}_{i}^{j} / N , ( i = 0 , 1 , … , K ) . \qquad ( 10 )$$

Here, Hᵢ^{j} denotes the Hᵢ for the mesh triangle Tⱼ.

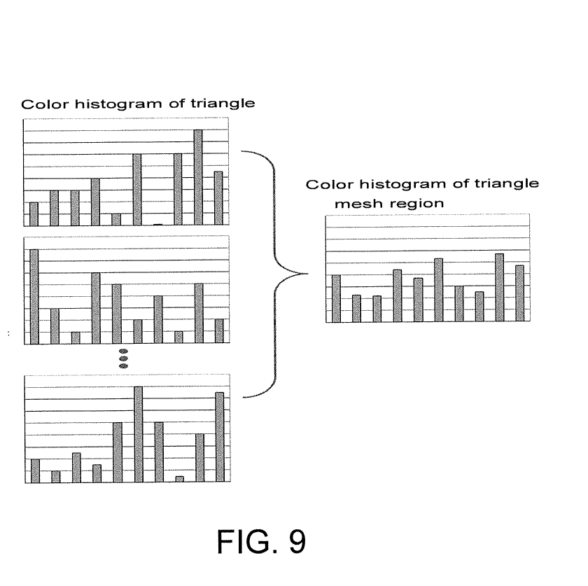

FIG. 9 illustrates the formation of the color histogram of triangle mesh region from the color histograms of triangles, in accordance with certain embodiments.

To represent the local content of the image, here the local patch feature, as shown at 512, may be computed in a manner known in the art, such as the manner disclosed in D. Lowe, Distinctive Image Features from Scale-Invariant Keypoints, Cascade Filtering Approach. IJCV, 60: 91-110, 2004, and the manner disclosed in H. Bay, et al., SURF: Speeded Up Robust Features. ECCV, I:404-417, 2006. For each feature point, a square region centered around the feature point is constructed, and the patch feature vector is extracted. Any feature transformation may be performed on such square patches to get the feature representation. For example, in certain embodiments, a patch feature may be constructed in accordance with the discussion on page 409-41 of H. Bay, et al., SURF: Speeded Up Robust Features. ECCV, I: 404-417, 2006. The usually adopted features include Haar feature, Gabor feature, histogram feature and the like. In accordance with certain embodiments, the patch feature is not limited to the Haar feature, Gabor feature, histogram feature or the like. Instead, the patch feature may be any one or more of various suitable image features.

A triangle mesh based image descriptor in accordance with certain embodiments describes local features of an image, e.g., patch description of each feature point, color histogram of image on each mesh triangle region and also describes the global structure feature of image through the neighboring relationship between mesh triangles, and the distribution scatter of triangle mesh. The constructed triangle mesh is affine invariant, i.e., scale-invariant, translation-invariant, rotation-invariant, and the like. Each triangle can accurately characterize its local content in the image, and the mesh scatter describes the texture density of the image.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), application specific integrated circuits (ASIC), and the like. The term “processor” and “memory” comprising executable instructions should be interpreted to include the variations described in this paragraph and equivalents thereof.

For example, in certain embodiments, functions, including, but not limited to, the following functions, may be performed by a processor executing computer-executable instructions that are recorded on a computer-readable medium: constructing a triangle mesh to describe an image based on feature points detected from the image; extracting a triangle mesh based descriptor from the constructed triangle mesh and from content of the image by computing a triangle structure, a triangle distribution scatter of mesh, a color histogram of triangle mesh region, and a patch feature; (a) computing lines composed by the detected feature points, P={P₁, P₂, . . . , P_{M}}, to produce a list of lines L={L₁, L₂, . . . , L_{K}}, where Lᵢ≦Lⱼ,if(i≦j) and K=M(M−1)/2; (b) selecting a line, Lᵢ, from L with a smallest length satisfies a condition that Lᵢ∉L_{B}; (c) taking Lᵢ to be a fixed line and constructing a triangle Tⱼ with a smallest perimeter based on the lines in L; (d) if Lᵢ=Lᵢ₊₁, comparing the perimeter of triangles Tⱼ and Tⱼ₊₁ and recording as Lᵢ the line corresponding to a smaller perimeter, recording as Tⱼ the corresponding triangle, and recording the other line Lᵢ₊₁; (e) adding the constructed triangle Tⱼ into the triangle mesh, T; (f) adding the three lines of the constructed triangle Tⱼ into a blank line set, L_{B}; (g) if one line of the added triangle Tⱼ can be used to construct triangle Tₘ with the lines in L_{B}, and Tₘ∉T, then set Tⱼ₊₁=Tₘ and add Tⱼ₊₁ into T; (h) deleting the element in L for the line intersected with the triangle Tⱼ; and repeating steps (b)-(h) until the blank line set equals the line list.

Embodiments include any novel feature or combination of features disclosed herein either explicitly or any generalization thereof. While embodiments have been described with respect to specific examples including presently preferred modes of carrying out the invention, those skilled in the art will appreciate that there are numerous variations and permutations of the above described systems and techniques. Thus, the scope of the invention should be construed broadly as set forth in the appended claims.

We claim:

1. A method comprising:
constructing a triangle mesh to describe an image based on feature points detected from the image; and
extracting a triangle mesh based descriptor from the constructed triangle mesh and from content of the image by computing a triangle structure, a triangle distribution scatter of mesh, a color histogram of triangle mesh region, and a patch feature.

2. The method of claim 1, further comprising: detecting the feature points from the input image.

3. The method of claim 1, wherein constructing the triangle mesh further comprises:
(a) computing lines composed by the detected feature points, P={P₁, P₂, . . . , P_{M}}, to produce a list of lines L={L₁, L₂, . . . , L_{K}}, where Lᵢ≦Lⱼ,if(i≦j) and K=M(M−1)/2;
(b) selecting a line, Lᵢ, from L with a smallest length satisfies a condition that Lᵢ∉L_{B};
(c) taking Lᵢ to be a fixed line and constructing a triangle Tⱼ with a smallest perimeter based on the lines in L;
(d) if Lᵢ=Lᵢ₊₁, comparing the perimeter of triangles Tⱼ and Tⱼ₊₁ and recording as Lᵢ the line corresponding to a smaller perimeter, recording as Tⱼ the corresponding triangle, and recording the other line Lᵢ₊₁;
(e) adding the constructed triangle Tⱼ into the triangle mesh, T;
(f) adding the three lines of the constructed triangle Tⱼ into a blank line set, L_{B};
(g) if one line of the added triangle Tⱼ can be used to construct triangle Tₘ with the lines in L_{B}, and Tₘ∉T, then set Tⱼ₊₁=Tₘ and add Tⱼ₊₁ into T;
(h) deleting the element in L for the line intersected with the triangle Tⱼ; and
repeating steps (b)-(h) until the blank line set equals the line list.

4. The method of claim 3, wherein step (d) further comprises: if the two perimeters for Tⱼ and Tⱼ₊₁ are equal, considering the secondary smaller perimeter based on Lᵢ and Lᵢ₊₁ to choose Lᵢ from lines with the same length.

5. The method of claim 1, wherein computing a triangle structure further comprises: assuming that the three angles of a mesh triangle Tⱼ are αⱼ,βⱼ,γⱼ and that the three angles are arranged counterclockwise such that αⱼ≦βⱼ,αⱼ≦γⱼ(γⱼ=π−αⱼ−γⱼ), based on a geometric structure feature of the triangle, defining a measurement to evaluate a degree of similarity of two triangles Tᵢ and Tⱼ as:
$$D = 1 - \frac{1}{π} ( ‖ {α}_{i} - {α}_{j} ‖ + ‖ {β}_{i} - {β}_{j} ‖ ) .$$

6. The method of claim 1, wherein computing the triangle distribution scatter of mesh further comprises computing a centroid cⱼ(xⱼ,yⱼ) of each triangle Tⱼ, computing a center point of the centroids for the triangles in the mesh as:
$${c}_{0} ( {x}_{0} , {y}_{0} ) = \frac{1}{N} {\sum }_{j = 1}^{N} {c}_{j} ( {x}_{j} , {y}_{j} ) ,$$
where N is a triangle number of a mesh, and computing the scatter R for triangle distribution of the mesh as:
$$R = \frac{1}{N \cdot Max ( W , H )} {\sum }_{j = 1}^{N} {d}_{j} ,$$
where, dⱼ=∥cⱼ(xⱼ,yⱼ),c₀(x₀,y₀)∥, and W and H are the corresponding width and height of the image, respectively.

7. The method of claim 1, wherein computing the color histogram of triangle mesh region further comprises: classifying the red, green, blue color space into a plurality of spaces and counting a number of pixels in each of the plurality of spaces.

8. The method of claim 1, wherein computing the color histogram of triangle mesh region further comprises: computing a color histogram H for each triangle Tⱼ as:
$${H}_{i} = {\sum }_{( x , y )} C \{ f ( x , y ) = i \} / n , ( i = 0 , 1 , … , K ) ,$$
where
$$\begin{matrix}f ( x , y ) = ( {I}^{R} ( x \cdot y ) / bin ) * bin * bin + \\ ( {I}^{G} ( x \cdot y ) / bin ) * bin + {I}^{B} ( x \cdot y ) / bin , \\ K = {max}_{( x , y )} ( f ( x , y ) ) ,\end{matrix}$$
bin is a category number classified for each color level, n is a total number of the pixels in the triangle Tⱼ, and C is a counting function, which is defined as:
$$C \{ f \} = \{ \begin{matrix}1 , & f is true \\ 0 , & f is false ,\end{matrix}$$
and integrating the color histograms to form a color histogram of triangle mesh region H^{Mesh} as:
$${H}_{i}^{Mesh} = {\sum }_{j = 1}^{n} {H}_{i}^{j} / N , ( i = 0 , 1 , … , K ) ,$$
where Hᵢ^{j} denotes the Hᵢ for a mesh triangle Tⱼ.

9. An apparatus comprising a processor and a memory containing executable instructions that, when executed by the processor, perform:
constructing a triangle mesh to describe an image based on feature points detected from the image; and
extracting a triangle mesh based descriptor from the constructed triangle mesh and from content of the image by computing a triangle structure, a triangle distribution scatter of mesh, a color histogram of triangle mesh region, and a patch feature.

10. The apparatus of claim 9, wherein the memory contains further executable instructions that, when executed by the processor, perform: detecting the feature points from the input image.

11. The apparatus of claim 9, wherein the memory contains further executable instructions that, when executed by the processor, construct the triangle mesh by:
(a) computing lines composed by the detected feature points, P={P₁, P₂, . . . , P_{M}}, to produce a list of lines L={L₁, L₂, . . . , L_{K}}, where Lᵢ≦Lⱼ,if(i≦j) and K=M(M−1)/2;
(b) selecting a line, Lᵢ, from L with a smallest length satisfies a condition that Lᵢ∉L_{B};
(c) taking Lᵢ to be a fixed line and constructing a triangle Tⱼ with a smallest perimeter based on the lines in L;
(d) if Lᵢ=Lᵢ₊₁, comparing the perimeter of triangles Tⱼ and Tⱼ₊₁ and recording as Lᵢ the line corresponding to a smaller perimeter, recording as Tⱼ the corresponding triangle, and recording the other line Lᵢ₊₁;
(e) adding the constructed triangle Tⱼ into the triangle mesh, T;
(f) adding the three lines of the constructed triangle Tⱼ into a blank line set, L_{B};
(g) if one line of the added triangle Tⱼ can be used to construct triangle Tₘ with the lines in L_{B}, and Tₘ∉T, then set Tⱼ₊₁=Tₘ and add Tⱼ₊₁ into T;
(h) deleting the element in L for the line intersected with the triangle Tⱼ; and
repeating steps (b)-(h) until the blank line set equals the line list.

12. The apparatus of claim 11, wherein the memory contains further executable instructions that, when executed by the processor, perform: in step (d), if the two perimeters for Tⱼ and Tⱼ₊₁ are equal, considering the secondary smaller perimeter based on Lᵢ and Lᵢ₊₁ to choose Lᵢ from lines with the same length.

13. The apparatus of claim 9, wherein the memory contains further executable instructions that, when executed by the processor, compute the triangle structure by performing operations comprising: assuming that the three angles of a mesh triangle Tⱼ are αⱼ,βⱼ,γⱼ, and that the three angles are arranged counterclockwise such that αⱼ≦βⱼ,αⱼ≦γⱼ(γⱼ=π−αⱼ−βⱼ), based on a geometric structure feature of the triangle, defining a measurement to evaluate a degree of similarity of two triangles Tᵢ and Tⱼ as:
$$D = 1 - \frac{1}{π} ( ‖ {α}_{i} - {α}_{j} ‖ + ‖ {β}_{i} - {β}_{j} ‖ ) .$$

14. The apparatus of claim 9, wherein the memory contains further executable instructions that, when executed by the processor, compute the triangle distribution scatter of mesh by performing operations comprising: computing a centroid cⱼ(xⱼ,yⱼ) of each triangle Tⱼ, computing a center point of the centroids for the triangles in the mesh as:
$${c}_{0} ( {x}_{0} , {y}_{0} ) = \frac{1}{N} {\sum }_{j = 1}^{N} {c}_{j} ( {x}_{j} , {y}_{j} ) ,$$
where N is a triangle number of a mesh, and computing the scatter R for triangle distribution of the mesh as:
$$R = \frac{1}{N \cdot Max ( W , H )} {\sum }_{j = 1}^{N} {d}_{j} ,$$
where, dⱼ=∥cⱼ(xⱼ,yⱼ),c₀(x₀,y₀)∥, and W and H are the corresponding width and height of the image, respectively.

15. The apparatus of claim 9, wherein the memory contains further executable instructions that, when executed by the processor, compute the color histogram of triangle mesh region by performing operations comprising: classifying the red, green, blue color space into a plurality of spaces and counting a number of pixels in each of the plurality of spaces.

16. The apparatus of claim 9, wherein the memory contains further executable instructions that, when executed by the processor, compute the color histogram of triangle mesh region by performing operations comprising: computing a color histogram H for each triangle Tⱼ as:
$${H}_{i} = {\sum }_{( x , y )} C \{ f ( x , y ) = i \} / n , ( i = 0 , 1 , … , K ) ,$$
where
$$f ( x , y ) = ( {I}^{R} ( x \cdot y ) / bin ) * bin * bin + ( {I}^{G} ( x \cdot y ) / bin ) * bin + {I}^{B} ( x \cdot y ) / bin , \\ K = {max}_{( x , y )} ( f ( x , y ) ) ,$$
bin is a category number classified for each color level, n is a total number of the pixels in the triangle Tⱼ, and C is a counting function, which is defined as:
$$C \{ f \} = \{ \begin{matrix}1 , & f is true \\ 0 , & f is false ,\end{matrix}$$
and integrating the color histograms to form a color histogram of triangle mesh region H^{Mesh} as:
$${H}_{i}^{Mesh} = {\sum }_{j = 1}^{N} {H}_{i}^{j} / N , ( i = 0 , 1 , … , K ) ,$$
where Hᵢ^{j} denotes the Hᵢ for a mesh triangle Tⱼ.

17. A computer-readable medium having recorded thereon computer-executable instructions, that, when executed, perform operations comprising:
constructing a triangle mesh to describe an image based on feature points detected from the image; and
extracting a triangle mesh based descriptor from the constructed triangle mesh and from content of the image by computing a triangle structure, a triangle distribution scatter of mesh, a color histogram of triangle mesh region, and a patch feature.

18. The computer-readable medium of claim 17, wherein the computer-readable medium has recorded thereon further executable instructions that, when executed by the processor, perform: detecting the feature points from the input image.

19. The computer-readable medium of claim 17, wherein the computer-readable medium has recorded thereon further executable instructions that, when executed by the processor, construct the triangle mesh by performing operations comprising:
(a) computing lines composed by the detected feature points, P={P₁, P₂, . . . , P_{M}} to produce a list of lines L={L₁, L₂, . . . , L_{K}}, where Lᵢ≦Lⱼ,if(i≦j) and K=M(M−1)/2;
(b) selecting a line, Lᵢ, from L with a smallest length satisfies a condition that Lᵢ∉L_{B};
(c) taking Lᵢ to be a fixed line and constructing a triangle Tⱼ with a smallest perimeter based on the lines in L;
(d) if Lᵢ=Lᵢ₊₁, comparing the perimeter of triangles Tⱼ and Tⱼ₊₁ and recording as Lᵢ the line corresponding to a smaller perimeter, recording as Tⱼ the corresponding triangle, and recording the other line L₁₊₁;
(e) adding the constructed triangle Tⱼ into the triangle mesh, T;
(f) adding the three lines of the constructed triangle Tⱼ into a blank line set, L_{B};
(g) if one line of the added triangle Tⱼ can be used to construct triangle Tₘ with the lines in L_{B}, and Tₘ∉T, then set Tⱼ₊₁=Tₘ, and add Tⱼ, into T;
(h) deleting the element in L for the line intersected with the triangle Tⱼ; and
repeating steps (b)-(h) until the blank line set equals the line list.

20. The computer-readable medium of claim 19, wherein the computer-readable medium has recorded thereon further executable instructions that, when executed by the processor, perform: in step (d), if the two perimeters for Tⱼ and Tⱼ₊₁ are equal, considering the secondary smaller perimeter based on Lᵢ and Lᵢ₊₁ to choose Lᵢ from lines with the same length.

21. The computer-readable medium of claim 17, wherein the computer-readable medium has recorded thereon further executable instructions that, when executed by the processor, compute the triangle structure by performing operations comprising: assuming that the three angles of a mesh triangle Tⱼ are αⱼ,βⱼ,γⱼ, and that the three angles are arranged counterclockwise such that αⱼ≦βⱼ,αⱼ≦γⱼ(γⱼ=π−αⱼ−βⱼ), based on a geometric structure feature of the triangle, defining a measurement to evaluate a degree of similarity of two triangles Tⱼ and Tⱼ as:
$$D = 1 - \frac{1}{π} ( ‖ {α}_{i} - {α}_{j} ‖ + ‖ {β}_{i} - {β}_{j} ‖ ) .$$

22. The computer-readable medium of claim 17, wherein the computer-readable medium has recorded thereon further executable instructions that, when executed by the processor, compute the triangle distribution scatter of mesh by performing operations comprising: computing a centroid cⱼ(xⱼ,yⱼ) of each triangle Tⱼ, computing a center point of the centroids for the triangles in the mesh as:
$${c}_{0} ( {x}_{0} , {y}_{0} ) = \frac{1}{N} {\sum }_{j = 1}^{N} {c}_{j} ( {x}_{j} , {y}_{j} ) ,$$
where N is a triangle number of a mesh, and computing the scatter R for triangle distribution of the mesh as:
$$R = \frac{1}{N \cdot Max ( W , H )} {\sum }_{j = 1}^{N} {d}_{j} ,$$
where, dⱼ=∥cⱼ(xⱼ,yⱼ),c₀(x₀,y₀)∥, and W and H are the corresponding width and height of the image, respectively.

23. The computer-readable medium of claim 17, wherein the computer-readable medium has recorded thereon further executable instructions that, when executed by the processor, compute the color histogram of triangle mesh region by performing operations comprising: classifying the red, green, blue color space into a plurality of spaces and counting a number of pixels in each of the plurality of spaces.

24. The computer-readable medium of claim 17, wherein the computer-readable medium has recorded thereon further executable instructions that, when executed by the processor, compute the color histogram of triangle mesh region by performing operations comprising: computing a color histogram H for each triangle Tⱼ as:
$${H}_{i} = {\sum }_{( x , y )} C \{ f ( x , y ) = i \} / n , ( i = 0 , 1 , … , K ) ,$$
where
$$f ( x , y ) = ( {I}^{R} ( x \cdot y ) / bin ) * bin * bin + ( {I}^{G} ( x \cdot y ) / bin ) * bin + {I}^{B} ( x \cdot y ) / bin , \\ K = {max}_{( x , y )} ( f ( x , y ) ) ,$$
bin is a category number classified for each color level, n is a total number of the pixels in the triangle Tⱼ, and C is a counting function, which is defined as:
$$C \{ f \} = \{ \begin{matrix}1 , & f is true \\ 0 , & f is false ,\end{matrix}$$
and integrating the color histograms to form a color histogram of triangle mesh region H^{Mesh} as:
$${H}_{i}^{Mesh} = {\sum }_{j = 1}^{N} {H}_{i}^{j} / N , ( i = 0 , 1 , … , K ) ,$$
where Hᵢ^{j} notes the Hᵢ for a mesh triangle Tⱼ.

25. A system comprising:
a triangle mesh constructor configured to create a triangle mesh by using a distance-minimum criterion on a plurality of feature points detected from an image;
a global descriptor computation module configured to compute global features based on the triangle mesh, wherein the global features describe a global representation of content of the image; and
a local descriptor computation module configured to compute local features based on the triangle mesh, wherein the local features describe a local representation of content of the image.

26. The system of claim 25, wherein the system further comprises: a feature point detector that detects the feature points from the image.

27. The system of claim 25, wherein the global features include a triangle distribution scatter of mesh that shows a texture density of the content of the image.

28. The system of claim 25, wherein the global features include a color histogram of mesh region that represents image color information corresponding to a mesh region of interest.

29. The system of claim 25, wherein the local descriptor computation module defines each mesh triangle shape via its three angles and computes a color histogram of each mesh triangle to represent image color information corresponding to each triangle region.

30. The system of claim 25, wherein the system further comprises: a patch feature computation module configured to compute a patch feature around a plurality of detected feature point regions based on the detected feature points of the image.

31. Apparatus comprising:
means for constructing a triangle mesh to describe an image based on feature points detected from the image; and
means for extracting a triangle mesh based descriptor from the constructed triangle mesh and from content of the image by computing a triangle structure, a triangle distribution scatter of mesh, a color histogram of triangle mesh region, and a patch feature.

32. The apparatus of claim 11, wherein the means for constructing the triangle mesh further comprises:
(a) means for computing lines composed by the detected feature points, P={P₁, P₂, . . . , P_{M}}, to produce a list of lines L={L₁, L₂, . . . , L_{K}}, where Lᵢ≦Lᵢ,if(i≦A) and K=M(M−1)/2;
(b) means for selecting a line, Lᵢ, from L with a smallest length satisfies a condition that Lᵢ∉L_{B};
(c) means for taking Lᵢ to be a fixed line and constructing a triangle Tⱼ with a smallest perimeter based on the lines in L;
(d) means for performing the following step: if Lᵢ=Lᵢ₊₁, comparing the perimeter of triangles Tⱼ and Tⱼ₊₁ and recording as Lᵢ the line corresponding to a smaller perimeter, recording as Tⱼ the corresponding triangle, and recording the other line Lᵢ₊₁;
(e) means for adding the constructed triangle Tⱼ into the triangle mesh, T;
(f) means for adding the three lines of the constructed triangle Tⱼ into a blank line set, L_{B};
(g) means for performing the following step: if one line of the added triangle Tⱼ can be used to construct triangle Tₘ with the lines in L_{B}, and Tₘ∉T, then set Tⱼ₊₁=Tₘ and add Tⱼ₊₁ into T.
(h) means for deleting the element in L for the line intersected with the triangle Tⱼ; and
means for repeating the steps set forth in (b)-(h) until the blank line set equals the line list.
